(19) United States
(12) Patent Application Publication
(10) Pub. No.: US 2010/0201544 A1
(43) Pub. Date: Aug. 12, 2010

(54) Method for Presenting Air Traffic Information on an Aircraft Head-up Display

(75) Inventors: Thierry Ganille, Merignac (FR); Regis Azarian, Merignac (FR); Eric Filliatre, Merignac (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/677,510

(22) PCT Filed: Sep. 12, 2008
(86) PCT No.: PCT/EP2008/062139

§ 371 Date: Mar. 10, 2010

(30) Foreign Application Priority Data
Sep. 14, 2007 (FR) 07 06466

(51) Int. Cl. G08G 1/01

(52) U.S. Cl. 340/933

(57) ABSTRACT

The general field of the invention is that of air traffic detection systems for a first aircraft, said system having detection capabilities in a region situated about said first aircraft, said system comprising at least one head-up display device, said device comprising means of generating, collimating and superimposing symbols on the external landscape intended to assist in the piloting of said first aircraft in the horizontal and vertical planes. When a second aircraft is detected by the air traffic detection system, the display device displays a specific system of symbols representative of the location of said second aircraft. The position and the configuration of this system of symbols depend on the position of the second aircraft in relation to the first. It also depends on the type of system, depending on whether the latter is an anticollision system or a guidance system.

The field of the invention is that of flight management systems for aircraft including a system for detecting or preventing collisions with other craft situated in the immediate environment of said aircraft and also comprising a collimated display device that can present symbols to assist in piloting or navigation. These display devices are also known by the term “Head-Up Display” or else “HUD”.

Current civilian aircraft are provided with traffic alert and collision avoidance systems, better known by their acronym “T-CAS”, which stands for “Traffic alert and Collision Avoidance System”. This system is intended to significantly reduce collisions between aircraft. It is mandatory on all craft exceeding a certain weight or transporting a certain number of passengers.

The “T-CAS” systems comprise at least one transponder, means of processing received data and at least one display means. An aircraft transponder is an onboard system which transmits a message concerning the aircraft when it receives an interrogation message. The message generally comprises a code identifying the craft together with more or less detailed information on the position of the craft. In aircraft that are provided with display screens, the “TCAS” function is incorporated in the screen dedicated to navigation, also called Navigation Display or “ND”.

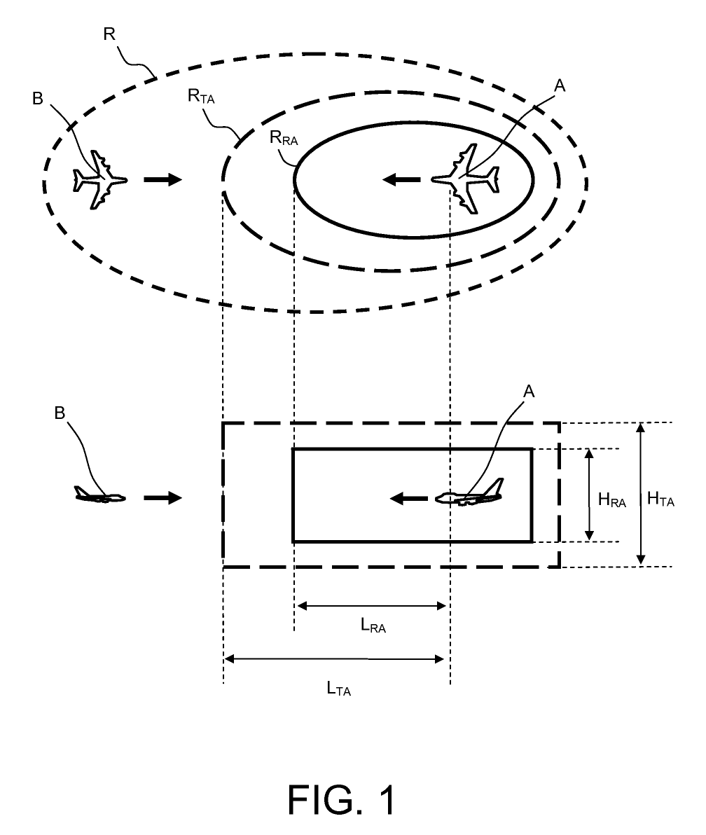

FIG. 1 represents the different regions covered by the “TCAS”, situated in the nearby environment of an aircraft A. The boundaries of these regions correspond to distances traveled by the airplane during predetermined times. Hereinafter, to give the distances in nautical miles, it has been assumed that the aircraft was flying at the cruising speed of 300 knots. FIG. 1 comprises two cross-sectional views, the first in a horizontal plane and the second in a vertical plane. The first region R, whose limits are represented by short broken lines, represents the maximum region covered by the “T-CAS” function. In this region, the “TCAS” function displays all the airplanes equipped with “TCAS” within a radius defined by the pilot, between 2.5 and 40 nautical miles depending on the speed of the craft. This region corresponds to a flight time of 4 minutes.

The second region R_{TA} represented by long broken lines represents a region within which another aircraft B can represent a risk of collision. The extreme limit L_{TA} of this region is 3.3 nautical miles in front of the aircraft A, which represents an average flight time of 40 seconds for a jetliner. It has a height H_{TA} of 2400 feet. If an airplane appears within this region and represents a potential danger of collision, a traffic notification is emitted by the device that is called “Traffic Advisory” or else “TA”. Said “TA” informs the pilot that another airplane is located nearby but does not suggest any avoidance manoeuvre. This other craft is called an “intruder”.

The third region R_{RA} represented by solid lines represents a region situated in the immediate environment of the aircraft A. The extreme limit L_{RA} of this region is 2.1 nautical miles from the aircraft A, which represents an average flight time of 25 seconds. It has a height H_{RA} of 1700 feet. In this case, if an airplane appears within this region, the situation is aggravated and the collision appears imminent, an audio message and a visual alert are produced by the device, called “Resolution Advisory” or else “RA”, indicating the aircraft concerned and signaling the action to be carried out by the pilot, namely either to maintain the current trajectory, or to climb, or to descend or else to monitor the vertical speed. This system is designed so that the “TCAS” of the other airplane recommends another manoeuvre. Very often, the “TCAS” indicates to the first airplane that it should climb and to the second airplane that it should descend, which considerably increases the separation between the two craft. When the alert is finished, the system announces the end of the conflict.

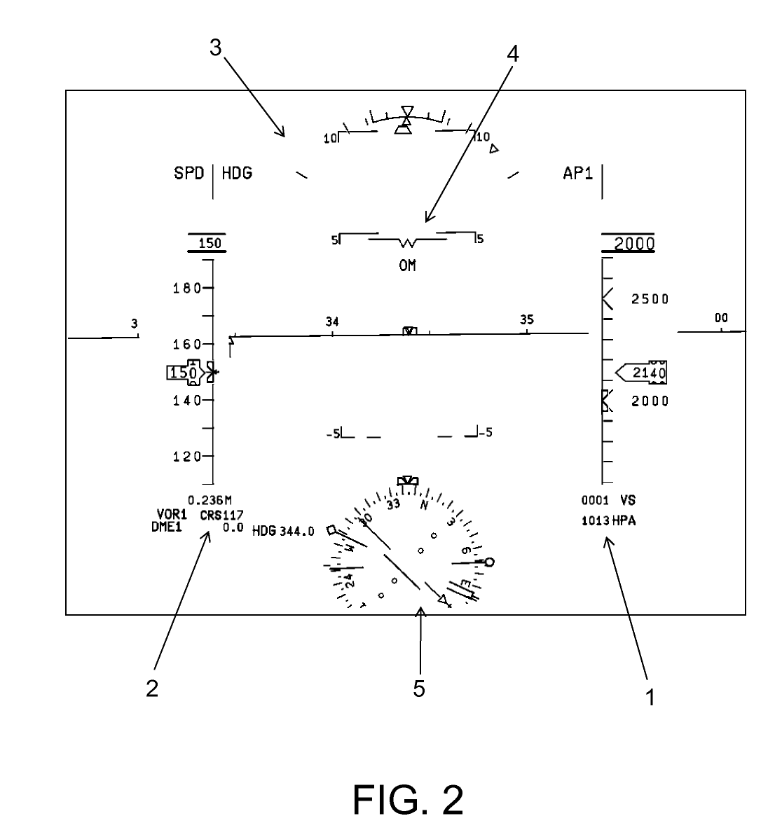

When the aircraft has a head-up display, the latter conventionally displays information concerning piloting or navigation. In a head-up display, such information is collimated to infinity and projected by superimposition on the external landscape. An example of this type of figuration is represented in figure 2. The pilot therefore simultaneously sees a projected system of symbols and the “real world” situated outside. In this figure and the subsequent figures, the external rectangle represents the limits of the display field of the display. There is conventionally, on the right of FIG. 2, an altitude scale 1 in feet, on the left a speed scale 2 in knots, in the middle, the horizon 3, the flight director 4 and, at the bottom of FIG. 2, the heading rose 5 with the indication of the path to be followed. As can be seen, this figure comprises a large number of symbols that vary constantly according to the position of the craft. In nominal mode, this system of symbols is perfectly suited to piloting and navigation.

These days, in civilian aeronautics, there is no head-up display system of symbols to assist in locating another airplane. In the case of “TCAS” alert, the airplane originating the alert is presented on the “ND” screen either by an amber circle for a “TA” (Traffic Advisory) alert, or by a red square for an “RA” (Resolution Advisory) alert. Around this symbol there is displayed, in the same color, the relative altitude of the threatening airplane in relation to the aircraft and the “trend arrow” to the right of the symbol. The “trend arrow” indicates whether the threatening aircraft is climbing, descending or flying level.

The aim of the inventive device is to assist the pilot in locating in the real world the position of a threatening airplane originating a current “TCAS” alarm and to provide the pilot with information on this threat. Such information is essentially the trend, the relative altitude and the relative distance of the threatening craft or “intruder”. For this, a symbol is displayed in the “HUD” that is representative of the “intruder”. This symbol has different representations depending on whether the threatening airplane is within the field of the “HUD”, whether the threatening aircraft is within the field of view of the pilot but outside the field of the “HUD” and, lastly, whether the airplane is outside the field of view of the pilot.

There is also a system called “ASAS”, an acronym which stands for “Airborn Separation Assurance System”, that can be used to guide a succession of craft in landing, take-off or cruising phases, notably for transatlantic crossings where air traffic is very dense. This system makes it possible to significantly reduce the safety distances separating two successive craft while, obviously, retaining the same level of safety. The approach or take-off procedures are thus notably facilitated. The invention can usefully be extended to the case of “ASAS” manoeuvres in order to assist the pilot in displaying the airplane that he is following in the context of such a manoeuvre and monitor its separation distance. In this case, a specific “ASAS” symbol is displayed in the “HUD”.

The inventive system offers numerous benefits. By displaying a system of symbols specific to the “intruder”, the pilot is assisted to locate an airplane originating a “TCAS” alert, and do so in the real world, and, on the other hand, the pilot is provided with certain information on this threat while the changing situation is monitored by direct vision. These days, no assistance is provided to the pilot for locating this type of threat in a system of symbols conforming with the real world and the trend, distance and relative altitude information concerning the threatening airplane is available only on the “ND” screen. This specific system of symbols enables the pilot to acquire an awareness of the situation more rapidly and in more detail than with the current systems, and to monitor by direct vision how the situation originating the “TCAS” alert changes. Time is a critical factor for avoiding a collision in as much as the pilot has only a few tens of seconds to react.

More specifically, the subject of the invention is an air traffic detection system for a first aircraft, said system having detection capabilities in a region situated about said first aircraft, said system comprising at least one head-up display device, said device comprising means of generating, collimating and superimposing symbols on the external landscape intended to assist in the piloting of said first aircraft in the horizontal and vertical planes, characterized in that, when a second aircraft is detected by the air traffic detection system, the display device displays a system of symbols representative of the location of said second aircraft.

Advantageously, in a first application, the system is an anti-collision system of the “TCAS” type, the second craft is situated in a first region where the collision between the first and the second aircraft is possible, the extreme limit of this first region corresponds to a flight time of 40 seconds for the first aircraft and this region has a maximum height of 2400 feet. In this case, there are three possible cases:
when the second aircraft is in the visual field of the head-up display device, the system of symbols is superimposed on said second aircraft and comprises a substantially square-shaped geometrical figure, an indication of the relative altitude of the second aircraft in relation to the first aircraft, a trend arrow indicating whether the second aircraft is climbing or descending and an indication of the relative distance of the second aircraft in relation to the first aircraft.
when the second aircraft is out of the visual field of the heard-up display device but is within the visual field of the pilot, the system of symbols is arranged at the periphery of the visual field of the head-up display device, in the same direction as the second aircraft and comprises a substantially square-shaped geometrical figure with a dotted outline, an indication of the relative altitude of the second aircraft in relation to the first aircraft, a trend arrow indicating whether the second aircraft is climbing or descending and an indication of the relative distance of the second aircraft in relation to the first aircraft.
when the second aircraft is out of the visual field of the pilot, the system of symbols is arranged on the left side of the altitude scale of the head-up device display and comprises a hollow arrow-shaped pointer arranged on the altitude scale at the altitude of the second aircraft, an indication of the relative altitude of the second aircraft in relation to the first aircraft, a trend arrow indicating whether the second aircraft is climbing or descending and an indication of the relative distance of the second aircraft in relation to the first aircraft, said pointer including an indication of the risk of collision.

Advantageously, in a second application, the system is a system for guiding a succession of aircraft, the first and the second aircraft forming part of this succession. In this case, there are also three possible cases:
when the second aircraft is in the visual field of the head-up display device, the system of symbols is superimposed on said second aircraft and comprises a substantially circular-shaped geometrical figure, an indication of the relative altitude of the second aircraft in relation to the first aircraft, a trend arrow indicating whether the second aircraft is climbing or descending and an indication of the relative distance of the second aircraft in relation to the first aircraft.
when the second aircraft is out of the visual field of the head-up display device but is within the visual field of the pilot, the system of symbols is arranged at the periphery of the visual field of the head-up display device, in the same direction as the second aircraft and comprises a substantially circular-shaped geometrical figure with a dotted outline, an indication of the relative altitude of the second aircraft in relation to the first aircraft, a trend arrow indicating whether the second aircraft is climbing or descending and an indication of the relative distance of the second aircraft in relation to the first aircraft.
when the second aircraft is out of the visual field of the pilot, the system of symbols is arranged on the left side of the altitude scale of the head-up display device and includes a hollow arrow-shaped pointer arranged on the altitude scale at the altitude of the second aircraft, an indication of the relative altitude of the second aircraft in relation to the first aircraft, a trend arrow indicating whether the second aircraft is climbing or descending and an indication of the relative distance of the second aircraft in relation to the first aircraft.

The invention will be better understood, and other benefits will become apparent, from reading the following description, given as a nonlimiting example, and from the appended figures in which:

FIG. 1 represents the different regions covered by the “TCAS”;

FIG. 2 represents a system of symbols according to the prior art represented in a collimated display device;

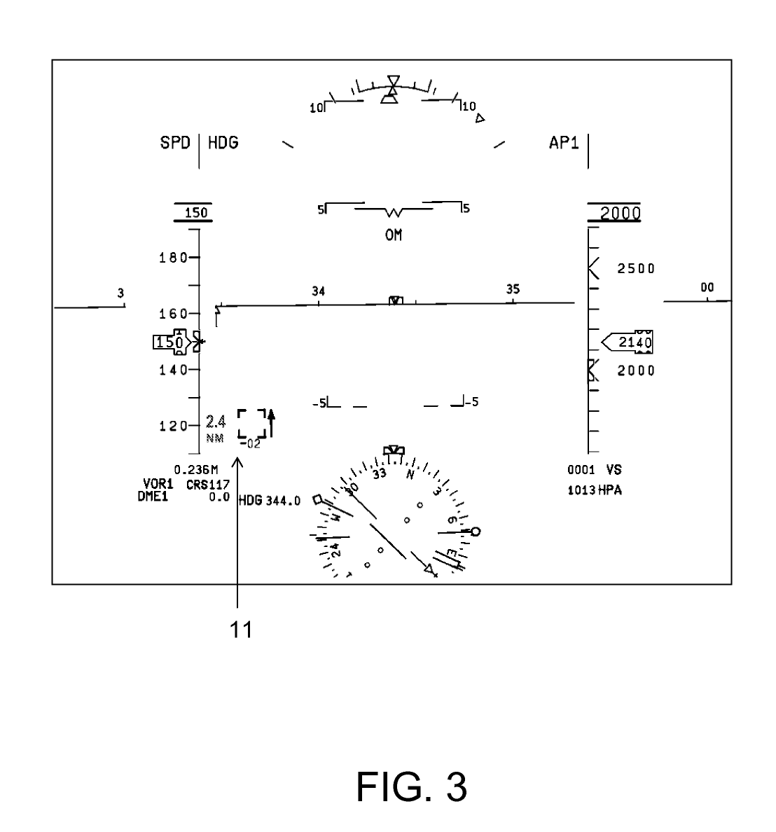

FIGS. 3, 4 and 5 represent different representations of the system of symbols according to the invention in the case of a “TCAS” system;

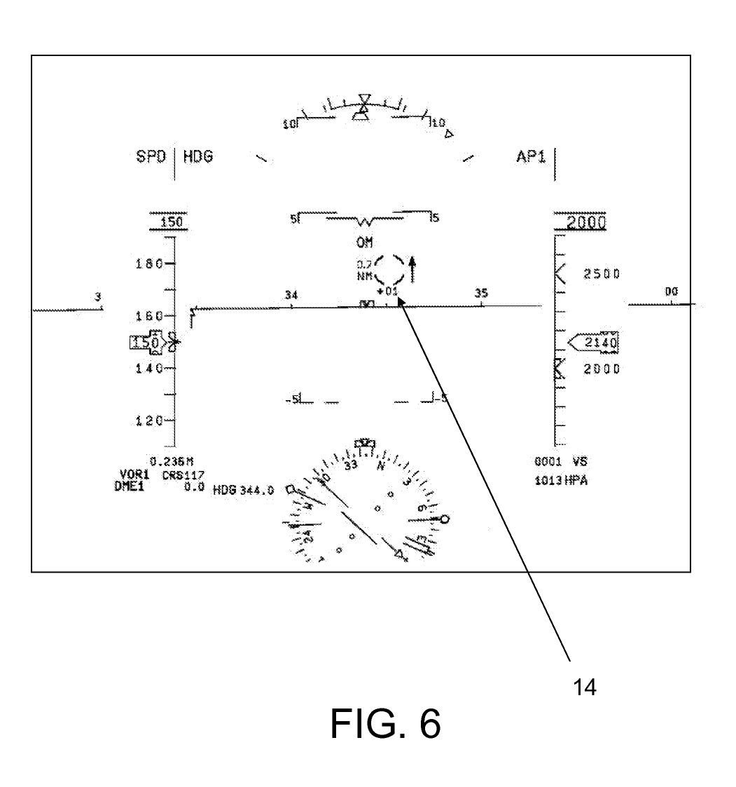

FIG. 6 represents an exemplary system of symbols according to the invention in the case of an “ASAS” system.

As has been stated, the air traffic detection system according to the invention comprises a head-up display device arranged so that, when a second aircraft is detected by the air traffic detection system, the display device displays a specific system of symbols representative of the location of said second aircraft. The system can be either an anti-collision detection system of “TCAS” type, or a system of “ASAS” type. In both types of systems, there are three distinct cases according to the relative position of the airplane originating the alert in relation to the aircraft which lead to three different symbols. These cases are detailed hereinbelow in the case of a “TCAS” type system and then in the case of an “ASAS” type system.

In the case of a “TCAS” type application, if the threatening aircraft is situated in the field of the “HUD” as illustrated in FIG. 3, a symbol 11 is then displayed which surrounds the threatening airplane in the real world. This symbol enables the pilot to immediately acquire the position of the threat in the real world and follow the changing situation. In the case of FIG. 3, this symbol is square shaped with only the corners represented. Around this symbol there is added, in a manner similar to what exists on a “TCAS” symbol displayed on an “ND” type screen:
the relative altitude of the threatening airplane in relation to the carrier. Thus, in FIG. 3, the indication “−02” placed under the square symbol means that the second aircraft is 200 feet under the first aircraft. It should be noted that, if the second aircraft is above the first, the indication becomes positive and is placed above the square symbol;
the trend arrow to the right of the symbol. The arrow is oriented upward if the threatening airplane is climbing, is oriented downward if it is descending. There is no arrow if the airplane is flying level.
Finally, the distance of the threat is added to the left of the symbol. In the case of FIG. 3, this distance is 2.4 nautical miles.

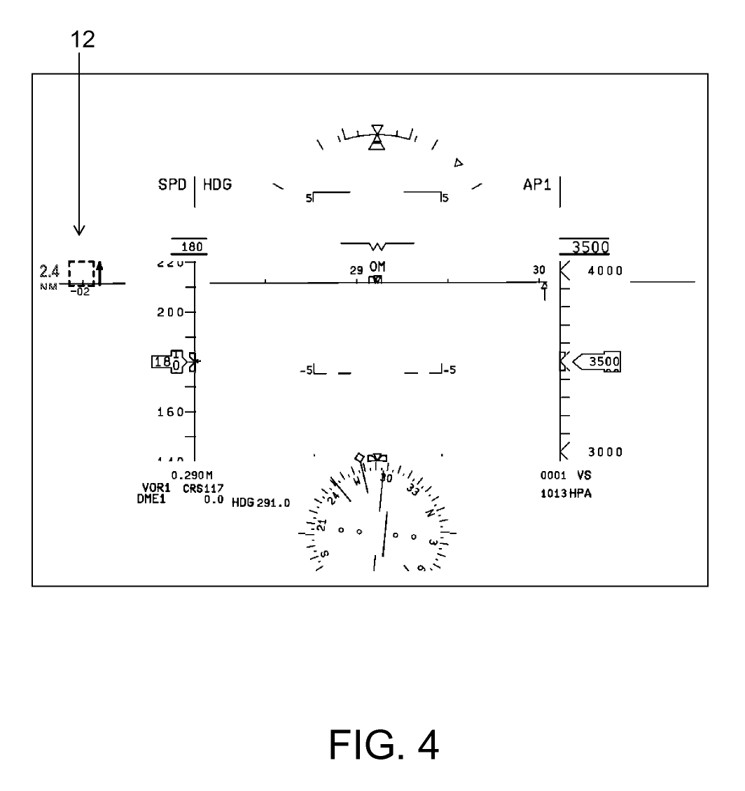

In the second case, the threatening airplane is situated outside the field of the “HUD”, but remains within the field of view of the pilot as illustrated in FIG. 4. The same symbol 12 is then displayed on the “HUD” as in the first case, but in dotted lines and placed abutting the periphery of the field of the display device. The symbol then indicates to the pilot the direction in the real world in which the threatening airplane is located. It affords the pilot an immediate perception of the origin of the danger and provides him with assistance if he wants to visually acquire the threat. Around this symbol, the same information is displayed as in the first case, that is to say, the relative altitude of the threatening airplane in relation to our carrier, the trend arrow and the distance of the threat.

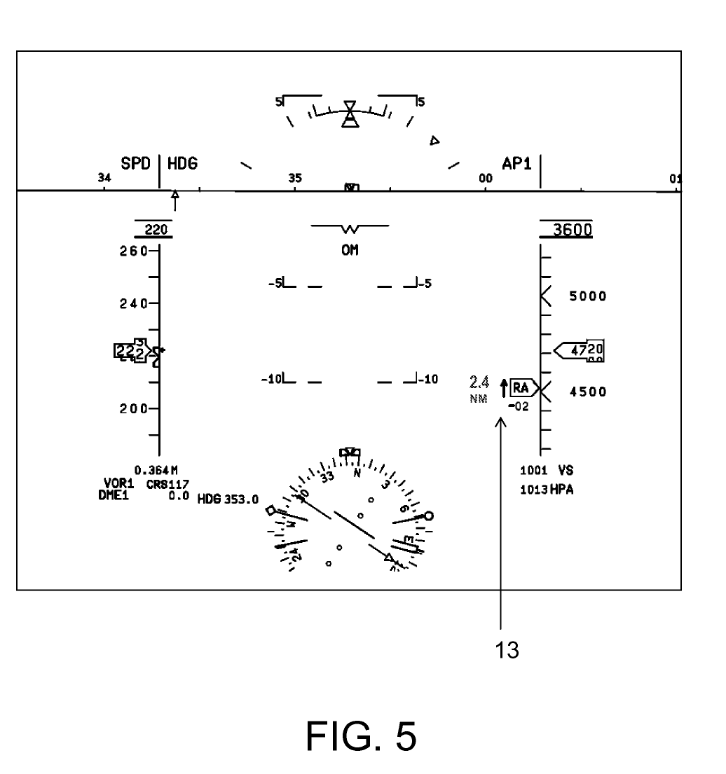

In the third case illustrated in FIG. 5, the threatening airplane is situated outside the field of view of the pilot. A symbol 13 is then displayed on the altitude scale of the “HUD”, on the left side so as not to come into conflict with the displayed altitude of the aircraft. This symbol is a hollow arrow-shaped pointer arranged on the altitude scale at the altitude of the second aircraft, said pointer comprising an indication of the risk of collision, which is, in the case of FIG. 5, the indication “RA” corresponding to the region within which the “intruder” is situated. The altitude of the threatening airplane is then indicated to the pilot. This symbol affords the pilot an immediate perception of his vertical situation in relation to the threat. Since the avoidance instructions in case of traffic alert are always in the vertical plane, the pilot can easily monitor the changing situation. The same information is displayed around this symbol as in the first two cases, that is to say, the relative altitude of the threatening airplane in relation to our carrier, the trend arrow and the distance of the threat.

Obviously, when the relative position of the two airplanes changes, it is possible to switch from one case to the other during the same alarm. The corresponding symbols can then follow one another.

Similar arrangements are found in the case of “ASAS” manoeuvres, in the case where the carrier receives the instruction from air traffic control to follow another airplane at a fixed distance. A priori, the three symbols described above can be used by replacing the square with a circle in the first two configurations and the tag “RA” with “AS” in the third case, when the aircraft is outside the field of view of the pilot. Because of the nature of the “ASAS” manoeuvre, this third case is improbable, and usually it will the first two cases that apply. As an example, FIG. 6 represents the system of symbols according to the invention in the first case, that is to say when the airplane being followed is situated within the field of the display device. A circular symbol 14 surrounds the followed airplane in the real world.

Here again, these symbols enable the pilot to facilitate the visual acquisition of the airplane to be followed and the implementation of the manoeuvre, for example by placing the speed vector of the carrier on the displayed “ASAS” symbol and monitor the maintaining of his distance throughout the time of the manoeuvre.

1. An air traffic detection system for a first aircraft, said system having detection capabilities in a region situated about said first aircraft, said system comprising at least one head-up display device, said device comprising means of generating, collimating and superimposing symbols on the external landscape intended to assist in the piloting of said first aircraft in the horizontal and vertical planes, wherein, when a second aircraft is detected by the air traffic detection system, the display device displays a system of symbols representative of the location of said second aircraft.

2. The system as claimed in claim 1, wherein the system is an anti-collision system of the “TCAS” type, that the second craft is situated in a first region where the collision between the first and the second aircraft is possible, the extreme limit of this first region corresponds to a flight time of 40 seconds for the first aircraft and this region has a maximum height of 2400 feet.

3. The system as claimed in claim 2, wherein, when the second aircraft is in the visual field of the head-up display device, the system of symbols is superimposed on said second aircraft and comprises a substantially square-shaped geometrical figure, an indication of the relative altitude of the second aircraft in relation to the first aircraft, a trend arrow indicating whether the second aircraft is climbing or descending and an indication of the relative distance of the second aircraft in relation to the first aircraft.

4. The system as claimed claim 2, wherein, when the second aircraft is out of the visual field of the heard-up display device but is within the visual field of the pilot, the system of symbols is arranged at the periphery of the visual field of the head-up display device, in the same direction as the second aircraft and comprises a substantially square-shaped geometrical figure with a dotted outline, an indication of the relative altitude of the second aircraft in relation to the first aircraft, a trend arrow indicating whether the second aircraft is climbing or descending and an indication of the relative distance of the second aircraft in relation to the first aircraft.

5. The system as claimed in claim 2, wherein, when the second aircraft is out of the visual field of the pilot, the system of symbols is arranged on the left side of the altitude scale of the head-up device display and comprises a hollow arrow-shaped pointer arranged on the altitude scale at the altitude of the second aircraft, an indication of the relative altitude of the second aircraft in relation to the first aircraft, a trend arrow indicating whether the second aircraft is climbing or descending and an indication of the relative distance of the second aircraft in relation to the first aircraft, said pointer including an indication of the risk of collision.

6. The system as claimed in claim 1, wherein the system is a system for guiding a succession of aircraft of “ASAS” type, the first and the second aircraft forming part of this succession.

7. The system as claimed in claim 6, wherein, when the second aircraft is in the visual field of the head-up display device, the system of symbols is superimposed on said second aircraft and comprises a substantially circular-shaped geometrical figure, an indication of the relative altitude of the second aircraft in relation to the first aircraft, a trend arrow indicating whether the second aircraft is climbing or descending and an indication of the relative distance of the second aircraft in relation to the first aircraft.

8. The system as claimed in claim 6, wherein, when the second aircraft is out of the visual field of the head-up display device but is within the visual field of the pilot, the system of symbols is arranged at the periphery of the visual field of the head-up display device, in the same direction as the second aircraft and comprises a substantially circular-shaped geometrical figure with a dotted outline, an indication of the relative altitude of the second aircraft in relation to the first aircraft, a trend arrow indicating whether the second aircraft is climbing or descending and an indication of the relative distance of the second aircraft in relation to the first aircraft.

9. The system as claimed in claim 6, wherein, when the second aircraft is out of the visual field of the pilot, the system of symbols is arranged on the left side of the altitude scale of the head-up display device and includes a hollow arrow-shaped pointer arranged on the altitude scale at the altitude of the second aircraft, an indication of the relative altitude of the second aircraft in relation to the first aircraft, a trend arrow indicating whether the second aircraft is climbing or descending and an indication of the relative distance of the second aircraft in relation to the first aircraft.
